(19) United States
(12) Patent Application Publication
(10) Pub. No.: US 2016/0292366 A1
(43) Pub. Date: Oct. 6, 2016

(54) SYSTEM AND METHOD OF COMBINING MEDICINAL PRODUCT INFORMATION OF MEDICAMENTS

(71) Applicant: ECBIG (E-COMMERCE & BUSINESS INTEGRATION) APS, Præstø (DK)

(72) Inventors: Henrik REICHE, Præstø (DK); Jesper REICHE, Langebæk (DK)

(73) Assignee: ECBIG (E-COMMERCE & BUSINESS INTEGRATION) APS, PRÆSTØ (DK)

(21) Appl. No.: 15/035,762

(22) PCT Filed: Nov. 10, 2014
(86) PCT No.: PCT/DK2014/000053

§ 371 Date: May 11, 2016

(30) Foreign Application Priority Data
Nov. 12, 2013 (DK) PA 2013 70670

(51) Int. Cl. G06F 19/00

(52) U.S. Cl. CPC G06F 19/326

(57) ABSTRACT

The present invention relates to a system and method for displaying any type of data or textual element of dismantled medicinal product information or aggregate effects, such as adverse reactions from multiple medicaments, or identifying one individual or a selection of information blocks, such as data, textual elements or contextual links of one medicament. The system comprises at least one computing device in which the dismantled medicinal product information of multiple medicaments are stored. Dismantled medicinal product information from multiple sources is entered into any number of input modules which divides the information into to a set of elements that are characterized, assigned properties and relationships according to a predetermined multi-dimensional information model. Phrases and terms in the information are standardised before registration. A user, whether health care professional or non-medical trained, communicates with the computing device via a communication module when selecting one or more medicaments. The computing device then generates a dedicated user interface comprising the dismantled medicinal product information of the selected medicaments. This provides a simple, effective and fast system for displaying any type of data or textual element of dismantled medicinal product information or aggregate effects such as adverse reactions of the selected medicament.

### FIELD OF THE INVENTION

The present invention relates to a system for managing dismantled medicinal product information of medicaments, such as identifying aggregate effects of the use of multiple medicaments or identifying at least one information block of dismantled medicinal product information of at least one medicament, where the system comprises
at least one computing device configured to store dismantled medicinal product information of a plurality of medicaments, wherein the dismantled medicinal product information at least comprises medicinal product characteristics of those medicaments;
at least one communication module coupled to the computing device and configured to communicate with at least one communication device;
where the communication device is configured to send a request to the computing device via the communication module and display the requested dismantled medicinal product information to a user of that communication device.

The present invention also relates to a method of managing dismantled medicinal product information of medicaments, such as identifying aggregate effects of the use of multiple medicaments or identifying at least one information block of dismantled medicinal product information of at least one medicament, where the method comprises the steps of:
storing dismantled medicinal product information of a plurality of medicaments on at least one computing device, wherein the dismantled medicinal product information at least comprises medicinal product characteristics of those medicaments;
sending a request from one or more users to the computing device using one or more communication devices, wherein the request indicates one or more selected medicaments;
receiving a reply from the computing device and displaying the selected dismantled medicinal product information to the user of the communication device.

The present invention also relates to specific uses of the system and method.

### BACKGROUND OF THE INVENTION

Medicine is a blessing of our age. Though not every problem may be cured by medicine most diseases may be treated and many prevented by use of medicine. One symptom or diagnosis is treated with one type of medicine, more symptoms with more types of medicine. As a result thousands of medicaments exist and millions of people worldwide use medicine every day. The recent years have seen a growing use of medicine especially as a preventive measure. In fact, an increasing number of people and particularly elderly is permanently using an increasing number of medicaments every day. The prescription of every individual medicament is well-founded on Evidence Based Medication (EBM) and medical guidelines. Nevertheless, medication may cause disease, hospitalisation or death. This is a known and acknowledged problem, but lately several scientific articles also establishes the fact that the negative effects of a longstanding permanent use of medicaments may offset the positive effects. This is described in several scientific articles, e.g. “Medication for older people—aspects of rational therapy from the general practitioners point of view” by M. Vass and C. Henriksen, June 2005.

The growing number of polypharmacy patients has led to official recommendations from health authorities as well as medical research workers to perform a regularly structured, critical examination of patient's medicine, particularly for elderly who acquire a growing risk of adverse reactions. It is, however, a recognised fact that for health care professionals it is very difficult to obtain an overview of effects and adverse reactions when three or more medicaments are used simultaneously. Therefore, there is a need for an evaluation of the overall picture of the used medicaments as pointed out in the article “Polypharmacy and older people—the GP perspective” by M. Vass and C. Henriksen, September 2005.

It's a surprising fact that all medicinal product information today is described only as a whole in textual formats which is presented either physically or electronically. These descriptions are more or less represented as text based books or documents without real searchable data or reusable information. The health care professionals, such as the practitioner or physician, have to read through large amount of textual information contained in often quite large electronically documents without specific data or identifiable content blocks in order to find specific information concerning aspects of the use of medicine. This is a very time-consuming process and involves a tremendous workload.

The current obvious difficulties in obtaining an overview of multiple medicaments may lead to even further medication. When poly-medicated patients seek medical attention their chief complaint may be identified by the practitioner as a symptom of additional disease rather than a possible aggregate adverse reaction. This may lead to prescription of additional medication instead of adjusting or reducing existing medication. Although polypharmacy can be appropriate, it is more often inappropriate. Concerns about polypharmacy include increased adverse drug reactions, drug-drug interactions, prescribing cascade, and higher costs. Polypharmacy is often associated with a decreased quality of life, decreased mobility and cognition.

US 2004/0010511 A1 discloses a POC system and method for preparing or tailoring a treatment plan for the specific patient's chief complaint (the symptom/problem that has brought the patient to see the doctor). The system compares the medical history of the patient with the medical information of a selected medicament or a list of drugs of a selected therapeutic class. The result is combined with relevant comments or treatment advices from other practitioners or experts concerning the main disease. The patient history, the medical information and possible test results are entered into the system and the system will then, by providing an artificial intelligence, assists the physician in asking the right questions to the patient, in performing the appropriate tests and finally in choosing the best medication and treatment plan for treating the main symptom. Though US 2004/0010511 relates to what in general terms may be labelled “medicine management”, a substantial numbers of methods, models and terms exist. Medicine management may have the objective as US 2004/0010511 to improve the clinician's decision of how to treat a specific disease and analyse how the treatment of one disease (the patient's chief complaint) may be improved either for the actual patient or in general. This objective is reflected in the term “Drug Utilization Review”, meaning the utilization of one specific drug or type of drug, leading to improved guidelines for either use of this drug or treatment of this specific disease. US 2004/0010511 is not designed to review the use of multiple medicaments in treating multiple symptoms or diseases and create an overview of the aggregate effects or establish an overview of all involved medicament's medicinal product information.

US 2012/0089547 A1 discloses a system and method of analysing the risk of adverse reactions resulting from the use of one particular medicinal product. The system comprises a data mining processor that applies a number of filters to the stored medical information and generates a result indicating the probability of the adverse reactions or identifying special precautions for this medicinal product, either for all patients or a type of patients, not the individual patient. US 2012/0089547 is designed for research purposes when approving or updating the medicinal product characteristics of one medicinal product, hence not designed for analysing several medicaments for one specific patient.

US 2004/0172285 A1 discloses a method and automated prescribing system for selecting a drug as treatment by using one symptom as search criteria when querying the full original document based information from the medicinal product supplier, providing some unspecified information about drugs. The method describes a process initiated from a symptom and delivering a drug, which is contrary to the present invention. Terminology is decisive for identifying similarities or differences. “Provide information about drugs” may not be considered technical or conceptual as representing all types of medicinal information as explained in a later section on terminology. “Drug database” may similarly not be considered as representing one common standardised concept. US 2004/0172285 A1 discloses a completely different objective and in every possible way a different method. It is neither capable of dismantling medicinal product information, nor dealing with nor combining dismantled medicinal product information from more medicinal products.

US 2010/0274586 A1 discloses a drug interaction utility based on the assertion that the risk of ADRs (Adverse Drug Reactions) increases with the number of medications because of interactions among the medications. Interactions are generally defined as a drug-drug interaction between two drugs and the utility is to all intents and purposes a system to use an existing drug-drug interaction database to provide product recommendations. US 2010/0274586 A1 has a completely different objective than the present invention. It does not deal with dismantled medicinal product information. It is not capable of combining dismantled medicinal product information from more medicinal products as it simply returns one information: the drug interaction result.

US 2008/0010088 A1 discloses a system (apparatus) for adverse drug reaction (ADR) reduction by taking a first medication (drug) together with a second medication (drug) and querying an ADR database in order to determine whether there is a potential conflict between medications (drugs). The potential conflict between drugs is exactly the definition of drug-drug interaction, which means that Adverse Drug Reactions in this case is used (wrongly) as synonym for drug-drug interactions, hence this apparatus is solely querying a drug-drug interaction database. US 2008/0010088 A1 is not capable of dealing with dismantled medicinal product information. It does not provide any information concerning any other aspect of medicinal information and is incapable of combining dismantled medicinal product information from more medicinal products.

U.S. Pat. No. 8,473,315 B1 discloses a method for detecting or diagnosing an adverse drug event experienced by a specific patient as a result of medication by establishing or calculating a risk for this specific patient of experiencing this specific symptom. The terminology used (“adverse drug event”) is quite ambiguous and self-contradictory as “adverse event” is a medical occurrence not necessary causally related to a medicinal product. The objective of U.S. Pat. No. 8,473,315 B1 is to evaluate if a prescribed medication/drug is safe for the patient by calculating a risk profile for the specific patient based on a number of characteristics of this patient, like age, sex, location together with observation data about the patient. U.S. Pat. No. 8,473,315 B1 specifically rejects the use of all other methods and medicinal information if no patient orientation is provided. It is based on a so-called “ADR-record” which is described as a database of symptoms comprising unspecified information about a symptom of medication. The system in other words relates its information to a symptom and possible synonyms of a symptom, assuming that an objective risk of a symptom exist and may be calculated for a specific patient. U.S. Pat. No. 8,473,315 B1 is a statistical risk calculation utility and is not dealing with dismantled medicinal product information. It is incapable of presenting or combining each and any medicinal product information of more medications/drugs.

WO 2012/122347 A1 discloses a method and system for improved health care by using an electronic medical record to provide information regarding a patient's drugs and generating alerts concerning potential adverse effects of a plurality of pharmaceutical preparations, food or herbals. “Potential adverse effects” include “side effects” of drug-drug interactions and effects of the patient's generic profile. The terms used represents a total confusion of all conventional terms as demonstrated in the later section describing the present invention. WO 2012/122347 use the term adverse effects/side effects as expressing drug-drug interactions and use the term “drug cluster” to express a historical record of a combination of drugs in a specific time period for a patient. The system queries a number of specified US databases like FDB and GENELEX database. It furthermore includes several modules like Alternative Drug Suggestor, HealthCare Burden Estimator, Rule & Alert Engine, and Shared Adverse Side Effects Predictor, which according to the description of the terms “Adverse Effects” and “Side Effects” is a drug-drug-interaction analyzer including the patient's genetic profile. The provided information about drugs in WO 2012/122347 is basically information concerning drug-drug interaction. The present invention does not involve the patient's genetic profile. The present invention is neither using any of the abovementioned modules, nor methods and is not querying nor depending on the described US databases. WO 2012/122347 is not dealing with dismantled medicinal product information. It is incapable of presenting or combining each and any medicinal product information of more medications/drugs.

US 2010/0125615 A1 discloses a method and system for processing a drug information source by extracting data in a manner to support use of the data with artificial intelligence tools. The key problem presented is differing terminology, that make conventional queries cumbersome and the results less reliable. US 2010/0125615 A1 unfortunately contributes to the terminology problems by confusing terms like adverse event, adverse reactions, drug, substances, medical group etc. The objective is to solve terminology problems in medicinal textual descriptions by creating a syntax based text analyzer to interpret rules from textual sentences, enabling meaningful statistical comparisons to be made. The present invention is not aiming at creating a syntax based text analyzer nor interpret rules nor enabling statistical comparisons. US 2010/0125615 A1 is not dealing with dismantled medicinal product information. It is incapable of presenting or combining each and any medicinal product information of more medications/drugs.

US 2010/0223068 A1 discloses a method and apparatus for computing one or more compound factors for a healthcare regimen such as compound risks and compound benefits with a corresponding compound conditional probability. The healthcare regimen may include healthcare components like drugs, nutraceuticals, herbals, vitamins, minerals, homeopathics, enzymes, fitness, excercise routines, and therapies. The system relies on public databases (First DataBank, Wolters Kluwer) to supply “frequency of incidence of a side effect reaction for a given drug” and also calculate the benefit of “absence of an adverse effect”. Finally the system, guided by the “Law of Total Probability”, presents a substantial number of mathematical and statistical methods to calculate the cumulative or combined risk of a particular side effect. The present invention is not dealing with such statistical and extremely theoretical approach and is not aiming at calculating any risk. Nor is it relying on any of the abovementioned public databases (DataBank, Wolters Kluwer). US 2010/0223068 A1 is not dealing with dismantled medicinal product information. It is incapable of presenting or combining each and any medicinal product information of more medications/drugs.

Thus, there is quite a potential in improving such systems and methods as described above and there is a call for development of a new and improved system and method which enables for a simple and fast identification of the aggregate effects of multiple medicinal products.

### OBJECT OF THE INVENTION

It is an object of the invention to provide a system that solves the abovementioned drawbacks in a simple and easy way.

Another object of the invention is to provide a system that enables the user to view the aggregate dismantled medicinal product information of multiple types of medicaments in a simple and effective manner.

Another object of the invention is to provide a system that enables the user to view one individual or a selection of information blocks of dismantled medicinal product information in a simple and effective manner.

Another object of the invention is to provide a system that combines dismantled medical information from multiple sources into a single set of information of a particular medicament.

Another object of the invention is to provide a method that enables for an identification of aggregate possible adverse reactions resulting from the use of multiple medicaments.

Another object of the invention is to provide a method that converts the medicinal product characteristics and other medical information into a standardised format with identifiable data or information elements.

### DESCRIPTION OF THE INVENTION

As mentioned above, the invention relates to a system for managing dismantled medicinal product information of medicaments characterised by
the computing device is configured to combine a first medicament with the dismantled medicinal product information of at least a second medicament and generate a dedicated package, e.g. a user interface, for the combined medicinal product information, wherein the computing device is configured to send a reply back to the user via the communication module.

This provides a doable system that manages dismantled medicinal product information of medicaments in a simple and effective manner. The system enables the user to combine dismantled medicinal product information of multiple types of medicaments in a simple and effective manner. This reduces the amount of workload needed to examine the medication of a polypharmacy patient and eliminates the need for consulting multiple books, web-pages or databases. The system provides a simple overview of the medicinal product information of the selected medicaments for the health care professional.

This enables and inspires health care professionals to examine whether any new symptoms experienced by the patient may derive from the use of multiple medicaments or is in fact a new symptom that requires a new treatment. This enables the health care professional to alter the already prescribed medicaments instead of simply prescribing a new medicament, thereby potentially reducing the patient's medication.

The previous description has focused on difficulties and advantages for health care professionals, but for patients or other non-medical trained persons difficulties and hence advantages may be even more distinct. Medicinal information is usually expressed in medical terms and on account of the volume of textual information provided for the public (i.e. the package leaflet) it is an insurmountable mission for nonmedical-trained persons to find, understand and exploit information concerning their medication. The invention includes layman's terms, hence enables the non-medical trained user to explore precise information concerning their medication as well as the aggregate effects of this medication. Using this powerful tool puts the patient in the position to take part in discussions with health care professionals concerning their own treatment, the so-called “patient-empowerment”.

Within this field of invention terminology is key. Inventions may use terms that from a superficial view seems to be synonyms but thorough inspection reveals distinct differences. The term “drug database” is a suitable example. A database is as collection of data that is organised so that its content can easily be accessed, managed, and updated. Hence a “drug database” contains data about drugs, but the term does not cover one common and generally accepted concept. It may be a repository of one patient's drugs, a repository of either drug grants, drug prices, drug sales statistics, drug label documents, drug-drug-interactions or drug test results, just to mention some. The term “medication” represents a special issue as the term represents different concepts in US and Europe. In US-terms it represents a drug or medicine, while it in Europe according to Oxford Dictionary it is “treatment using drugs” in other words the cumulative use of drugs. The European definition applies to the use in this present invention. The term “aggregate effect” is defined as the combined effect of the use of at least two medicaments, such as interactions or adverse reactions or any other combined effects. The term “medicament” is defined as any type of substance or compositions of substances used to diagnose, treat, prevent, cure or alleviate diseases or illnesses or symptoms thereof whether traditional pharmaceutical product or herbal medicinal product or other untraditional type of medicinal product. The term “medicinal product characteristics” is defined as detailed information relating to the properties of the medicament, therapeutic indications and contraindications, adverse reactions or side effects, packaging, administration methods, interactions with other medicaments or products, patient types, storage, dosage, and other relevant detailed information. The term “medicinal product information” is defined as all information concerning a medicinal product, found in different sources, such as the official summary of product characteristics (also called SPC), the enclosed package leaflet (also called package insert), information from public health authorities, information from other public or private databases, therapeutic advice, therapeutic guidelines, organisational or other relevant sources. The term “dismantled medicinal product information” represents the overall medicinal product information as divided into constituent information blocks according to the multi-dimensional information model in this invention. The term “polypharmacy” is defined as the use of multiple medicaments by a patient, generally older adults (those aged over 65 years), including the purport of excessive or unnecessary prescriptions. More specifically, it is often defined as the use of five or more regular medicaments. The term “multi-dimensional information model” represents (in this domain of medicinal product information) a set of concepts related to medicinal products, their type and properties and interrelationships of those concepts, corresponding to what in computer and information science may be known as an ontology. The term “information block” is defined as a unit of information that constitutes a semantic whole on its own. The semantic message is reusable and may be used in many different contexts but makes sense on its own. The term “Evidence Based Medicine (EBM)” is defined as the conscientious, explicit and judicious use of current best evidence in making decisions about the care of individual patients. As stated in the section “Background of the invention” several inventions deal with drug therapy problems. The term “drug therapy problem” is defined as an undesirable event, a patient experience that involves, or is suspected to involve drug therapy, and that actually or potentially interferes with a desired patient outcome. Unfortunately several different terms are used to describe a drug therapy problem: “Adverse Drug Reactions”, “Adverse Reactions”, “Side Effects”, “Adverse Drug Event”, “Adverse Effects”, “Adverse Event”, “Adverse Drug Effect”. It must be noted that these terms are NOT synonyms and WHO, FDA as well as UK-MRHA clarifies the terms on their websites. The current invention uses the term “Adverse Reaction” as according to the mentioned institutions is “A response to a drug/medicinal product which is noxious and unintended and which occurs at doses normally used in man for prophylaxis, diagnosis, or therapy of disease or for modification of physiological function”. The phrase “responses to a medicinal products” means that a causal relationship between a medicinal product and an adverse event is at least a reasonable possibility, i.e., the relationship cannot be ruled out. Note that the definition as well as the explanation refers to a (=one) drug/medicinal product, which generally excludes a response to mutual effects of two drugs/medicinal products, for which this current invention uses the term “interaction”. Note also that this term may include responses by off-label use, overdose, misuse, abuse and medication errors. The old term “Side Effect” has been used in various ways in the past, usually to describe negative (unfavourable) effects, but also positive (favourable) effects. It is recommended that this term no longer be used and particularly should not be regarded as synonymous with adverse event or adverse reaction. The term “Adverse Event” is defined by the institutions as “Medical occurrence temporally associated with the use of a medicinal product, but not necessarily causally related.” Note that the term “Adverse Drug Event” may appear to correspond to “Adverse Event”, but in fact this definition clearly states that the event is not causally related to the drug. In this sense the term “Adverse Drug Event” is (self-)contradictory. WHO, FDA as well as UK-MRHA distinguishes between an unintended response caused by one individual drug/medicinal product and an unintended response caused by two concomitant administered drugs/medicinal products, which is labelled “interactions”: “Interactions may occur between drugs which compete for the same receptor or which act on the same physiological system. They may also occur indirectly when a drug-induced disease or a change in fluid or electrolyte balance alters the response to another drug. In addition, interactions may occur when one drug alters the absorption, distribution or elimination of another drug, such that the amount which reaches the site of action is increased or decreased”. The text several times refers to a scenario, where health care professionals “examines” or “evaluates” medication of a patient. This scenario may be defined as “an evaluation of a patient's current medication with the aim of optimizing the outcome of medicine therapy by detecting, solving and preventing drug-related problems, possibly with the objective of reaching an agreement with the patient about treatment”. No official definition exist for the term, and several terms are used internationally, terms which are far from identical and may in fact have very different meaning, like “drug or medication regimen review” (DRR/MRR), “drug or medication utilization review” (DUR/MUR), “comprehensive medication review” (CMR), “home medication review” (HMR), “clinical medication review” (CMR), or “medication management service” (MM service).

The abovementioned computing device may be configured as any number of servers or a cloud, i.e. a network of computing devices, such as servers. The computing device may comprise a controller controlling the operation of the computing device and may be coupled, e.g. loosely coupled, to any number of communication devices. The controller may be further coupled to a storage module in the form of a database or any other type of storage located on the computing device itself or a separate database or any other type of storage, coupled to the computing device, in which storage module the dismantled medicinal product information may be stored. The controller may control the data transfer between the communication devices and the storage module. Any number of central servers/clouds may be used where the dismantled medicinal product information is stored on one server/cloud, while the controller, communication module and other modules are implemented on another server/cloud; or everything may reside on a single server/cloud. The communication module may be configured to communicate with the communication device via a wired communication path, such as a PSTN or another wired Internet connection, or a wireless communication path, such as a WIFI or another wireless Internet connection or even a mobile data network. Whenever the term “configured” is used in this document, it relates to the overall set-up of the element (module and/or device) enabling it to perform the desired task. This enables the user to communicate with the computing device via a stationary unit or a mobile unit.

According to one embodiment, the computing device further comprises any number of input modules configured to process medicinal product information from one or more sources, wherein the input modules are configured to divide the medicinal product information into a set of elements and characterize, assign properties and relationships to them according to a predetermined information model, e.g. a multi-dimensional information model.

This enables the system to gather dismantled medicinal product information from multiple sources, such as public health authorities, public databases, public SPCs and package leaflets, or other relevant public, private or organisational sources. The system may further be configured to process the data, i.e. the information, presented in an electronic or physical form and in different formats, such as different textual formats. The dismantled medicinal product information may be entered into the input module automatically by loading the data into input module which then processes the data. The medical information may be entered into the input module manually or semi-automatically by an operator via one or more predetermined user interfaces, e.g. graphical user interfaces.

The input module may divide the medicinal product information into multiple elements according to a predetermined multi-dimensional information model of medicinal product information. The information model may be defined by a complex model comprising a predetermined set of elements which are arranged in one or more groups defining a predetermined number of interrelated information blocks. The groups may define the properties like therapeutic indications, contraindications, adverse reactions, packaging, administration methods, interactions, patient types, storage, dosage, unintended incidents, guidelines, direct healthcare professional communication and other relevant aspects. Each group may comprise a thesaurus with one or more sub-groups according to an international recognised classification system, e.g. the international classification of diseases (ICD), the international classification of primary care (ICPC) or the anatomical therapeutic chemical (ATC) classification system. The sub-groups may define various diseases, different dosages, different methods of administration and other relevant aspects. The elements and/or the groups may be linked together according to a predetermined interrelation, which may be fixed or contextual and may itself constitute an information block. The dismantled medicinal product information from the different sources may be combined in a single set of information for each medicament.

This enables dismantled medicinal product information of more medicaments to be combined into a single set of information for easier viewing and eliminates the need for consulting multiple databases or individual sources. This provides a very doable and effective system, since the system can handle any type of medicaments for any type of patients.

According to a specific embodiment, the input modules are coupled to any number of standardization modules configured to convert the information into a predetermined standardised format.

This enables the system to compensate for the various phrases and terms normally founded in the different types of sources due to different authors. The standardisation module may be configured to automatically recognise different phrases or terms and replace them with predetermined phrases or terms. The standardisation process may be carried out by the operator in a manual or semi-automatic manner. The standardisation module may be configured to automatically recognise phrases or terms and highlight to the operator which then replaces them with predetermined phrases or terms. The standardised phrases and/or terms may be internationally recognised phrases and/or terms defined by an international organisation and/or medical terminology used by professionals or the public health authority. The standardised phrases and/or terms may be stored in a storage module in the form of a database or any other type of storage coupled to the input module. This storage module may be located on the computing device itself or a separate storage module coupled to the computing device. The storage module may be updated continuously or periodically with new phrases and/or terms or updated by the operator when needed. This enables the medical information to change shape from phrases in a textual document, whether physical or electronical to well-defined and reusable information blocks with well-defined standard phrases and terms.

According to one embodiment, the communication module is configured to determine the type of communications device and/or the type of user based on the received request. This enables the communication module to at least identify the type of communication device used by the user. The communication module may be configured to automatically identify the type of communication device based on the unique identifier, e.g. the ID-number or IP-address, embedded in the request. The communication module may further be configured to identify the user, e.g. by the IP-address or another unique identifier. The user may be requested to indicate the type of device used and/or the type of user, when accessing a website located on the computing device. The communication device may be a stationary computer unit, a personal digital assistant, a tablet or laptop computer, a mobile phone, i.e. a smart-phone, or another type of communication device. This information is then embedded in the request and transmitted to the computing device. This enables the computing device, e.g. the controller, to generate a dedicated user interface for that user and that communication device.

The communication module may be configured to communicate with the user via an application downloaded and installed in the communication device. The type of communication device and/or type of user may be pre-loaded into the application before transmitting the request. The communication device may communicate with the computing device via Internet Explorer, Google Chrome, Mozilla Firefox, Safari or any other web browser.

According to one embodiment, the computing device is configured to generate a dedicated user interface based on the type of communications device and/or the type of user, wherein the dedicated user interface is configured to display the dismantled medicinal product information of the selected medicaments.

This enables the user to view the dismantled medicinal product information for all the selected medicaments, i.e. a combined overview, as well as the dismantled medicinal product information for each of the individual medicaments, i.e. an individual view. The computing device may be configured to retrieve the requested data from the database or any other type of storage and then combine into a dedicated package in the form of a user interface, e.g. a dedicated webpage or graphical user interface. This enables a faster overview, since the user is only presented with the dismantled medicinal product information for the selected medicaments. The dedicated user interface, e.g. the graphical user interface, may be integrated into the reply and transmitted to the user. This enables the user to view the selected dismantled medicinal product information even if the communication device is offline. A link to the dedicated user interface, e.g. the webpage, may be integrated into the reply and transmitted to the user. This enables the user to access the dedicated user interface via the link, thus reducing the amount of the data transmitted to the user. The user may enter the names of the medicaments and transmit them to the computing device or select the medicaments using one or more lists on a webpage located on the computing device or the communication device itself. The proprietary or standardised names of the medicaments may also be grabbed and parsed from an input string, provided either from a clinical system, a web browser or any other system containing a list of one or more medicaments.

The generated dedicated user interfaces may be stored in a storage module in the form of a database or any other type of storage located on the computing device. Each dedicated user interface may be provided with a unique identifier, e.g. the version, or date indicating when it was generated. The computing device, e.g. the controller, may be configured to check the storage module when a user sends a request. If a dedicated user interface matching the request is already stored in the storage module, then this user interface or a link to it is transmitted to the user. If not, a new dedicated user interface is generated and may be stored in the storage module after which a reply is send to the user. The computing device, e.g. the controller, may further be configured to check if the dismantled medicinal product information stored in the dedicated user interface is up-to-date before sending a reply. If not, the computing device may generate a new dedicated user interface or simply update the dismantled medicinal product information in the user interface.

The dedicated user interface may be adapted to the particular type of user. The user may be a physician or doctor, a dentist, a pharmacist, a patient or another medical or non-medical trained person. This enables the user interface to be optimised for the particular user allowing for a tailored and easier overview of the selected medicinal product information. The user interface for a practitioner, such as a physician or dentist, may differ from the user interface for a patient or another non-medical trained person.

The computing device is further configured to recognise one or more elements, e.g. adverse reactions, common for two or more of the selected medicaments and count the number thereof. The count may be configured to be displayed on the dedicated user interface, e.g. also if the element is only found in one of the selected medicaments. The computing device may optionally be configured to highlight or otherwise indicate on the user interface the elements having a count over a predetermined threshold, e.g. when that element is found in at least half of the selected medicaments. This may be done for the elements found in one or more of the groups. This enables the system to direct the user's attention to information or elements that are of an important nature, e.g. interactions, adverse reactions, contraindications, unintended incidents, lab-test, radiology or operation considerations, guidelines, etc.

As mentioned above, the invention relates also to a method managing dismantled medicinal product information of medicaments characterised by:
the computing device combines a first medicament with the dismantled medicinal product information of at least a second medicament and generates a dedicated package, e.g. a user interface, for the combined medicinal product information, wherein the computing device sends a reply back to the user.

This provides a quick and simple method of the viewing the aggregate dismantled medicinal product information of all medicaments used by a patient. This enables the user to view the dismantled medicinal product information for any type medicaments for any type of patients, thus providing a doable and effective way of examining the total medication of a patient, particularly a polypharmacy patient. This enables a health care professional or a patient to realise that a new or additional symptom experienced by the patient may result from medication rather than representing an additional disease, without consulting multiple text books, web-pages or databases. This further enables a health care professional or a patient to obtain a specific overview of concrete types of information for the total medication.

The user may communicate with the computing device via at least one communication module coupled to the computing device or integrated into the computing device. The communication module may be set up to communicate with the computing device via a wired or wireless communication path, such as a PSTN connection, a WIFI connection, a mobile data network, or another suitable network or it may be integrated in the system itself. This increases the versatility of the system, since the user can communicate with the system using different types of communication devices.

According to one embodiment, the medicinal product information from one or more sources are processed in any number of input modules on the computing device, wherein the input modules divide the medicinal product information into a set of elements and characterize, assign properties and relationships to the elements according to a predetermined information model, e.g. a multi-dimensional information model.

This enables the medicinal product information normally found in large textual documents or books, whether physical or electronical to be loaded into a predetermined multi-dimensional information model of medicinal product information. The data and textual information in the medicinal product information document is divided up into a set of data or textual elements for each medicament. The elements which form individual information blocks are then arranged in one or more groups or their sub-groups according to the multi-dimensional information model. This enables the medicinal product information to be arranged in well-defined and reusable information blocks which enables the user to retrieve a relevant block of information no matter the source.

Medicinal product information from multiple sources may be gathered and entered into the system using any number of input module coupled to the computing device or integrated into the computing device. The information relating to the medicaments may be collected from different types of sources, such as public health authorities, public databases, public SPCs and package leaflets, or other public, private or organisational sources. The data may be processed automatically or semi-automatically in the input module which analyses the data and recognises the elements based on one or more predetermined parameters, e.g. set up by the operator. Data may alternatively or additionally be entered into the input module manually by the operator, e.g. via a graphical user interface.

The information model enables the various types of dismantled medicinal product information to be combined into a single set of information for easier viewing, thus eliminating the need for consulting multiple databases or sources. The amount of information may further be reduced by omitting any duplicates of the same information found in more than one source. This provides a very doable and effective method that is suitable for any type of medicaments for any type of patients.

According to a specific embodiment, the output of the input modules is transferred to any number of standardisation modules which convert the information into a predetermined standardised format.

This enables any grammatical, linguistic and otherwise ambiguous phrases, terms or synonyms used in the medicinal product information to be converted into an identifiable and well-defined standard phrase or term. The phrases and/or terms may be recognised automatically by the standardisation module and optionally highlighted for further examination. The conversion of the phrases and/or terms may be done automatically by the module according to a register of standardised phrases and terms or manually by the operator. The operator may optionally update the register of standardised phrases and terms when dismantled medicinal product information is loaded into the system via the input module. The register of standard phrases and terms enables a unique identification and retrieval of information across the medicaments.

According to one embodiment, the type of communication device and/or the type of user is determined by the computing device based on the received request, and a dedicated user interface is generated by the computing device based on the type of communication device and/or the type of user.

This enables at least the user interface of the user to be adapted to a particular type of communication device, such as a stationary computer unit, a personal digital assistant, a tablet or laptop computer, or a mobile phone, e.g. a smart-phone. This enables a more optimal view of the dismantled medicinal product information on the communication device. The communication module on the computing device may identify the type of device based on the IP-address or unique identification embedded in the device. Alternatively an identification algorithm may be used to identify the device.

The view of the dismantled medicinal product information may be further improved by a dedicated user interface designed for a predetermined type of user, such as a physician or doctor, a dentist, a pharmacist, a patient or another medical or non-medical trained person. The user may be requested to select a predetermined user type which is then integrated into the request to the computing device. The computing device then generates a dedicated user interface, e.g. a webpage or graphical user interface for the select user type. The dismantled medicinal product information for the selected medicaments is then presented using this dedicated user interface. This enables the dismantled medicinal product information to be arranged for a more optimal view of the user. If the user communicates with computing device using an application implemented in the communication device, then the data relating to the type of device and user may be loaded and stored in the application prior to sending the request.

The computing device may send a link back to the user, indicating the location of the dedicated user interface, if the dedicated user interface itself, or adequate information for the communication device to build the user interface, is not send to the user. The dismantled medicinal product information in the dedicated package defining the dedicated user interface may be arranged so that the user may view the dismantled medicinal product information for all the selected medicaments as well as the dismantled medicinal product information for one or more of the individual medicaments. This enables the user to view the dismantled medicinal product information for all the selected medicaments, i.e. a combined overview, as well as the dismantled medicinal product information for each of the individual medicaments, i.e. an individual view.

When a dedicated user interface is generated on the computing device, the user interface may then be stored in a storage module in the form of a database or any other type of storage coupled to or integrated into the computing device. The user interfaces may be stored with a unique identification, e.g. the version of the dismantled medicinal product information, or the generation date. When another user sends the same request, then the computing device may send that dedicated user interface or a link thereof to that user. The computing device may update the dismantled medicinal product information before sending the link or the user interface, which reduces load on the computing device and gives quicker responses.

In a preferred embodiment, the computing device counts the number of selected medicaments in which one or more of the elements are found and optionally displays on the dedicated user interface an indication of frequency of the count of that element. This enables the user to quickly identify any type of information that is common for more than one medicament; the significance of this feature grows with the number of medicaments and is particularly relevant for polypharmacy patients. The computing device may count the number of medicaments in which each or a number of the elements are found. Elements which do not occur in any of the selected medicaments may be omitted from the dedicated user interface. The dedicated user interface may be arranged to indicate the count or characteristics for the elements, e.g. by means of a number, a colour or any graphic expression. The dedicated user interface may comprise a number of graphic areas, e.g. for selecting, filtering or omitting one or more of the groups, displaying the elements of that group, displaying a selection of the elements or a special selection of elements.

As mentioned above, the invention also relates to a specific use of the system or method as described above to identify aggregate effects, such as adverse reactions, resulting from the use of at least two medicaments.

The system and method described above is particularly suited to identify adverse reactions and/or interactions that are common for at least two medicaments. The real effect of a common adverse reaction from more medicaments may only be estimated by clinical tests, but the huge number of possible combinations makes this impracticable. The probability of a common adverse reaction may, however, be indicated by the number of medicaments having this adverse reaction and the individual probability of this adverse reaction of each individual medicament.

This enables a health care professional or even the patient himself to identify one or more adverse reactions that corresponds to the patient's chief complaint. As adverse reactions often may be mistaken as a new symptom when more medicaments are used leading to additional medication, this feature may instead lead to an adjustment of the patient's medication.

As mentioned above, the invention also relates to a specific use of the system or method as described above to identify one or more information blocks of dismantled medicinal product information of one or more medicaments.

The system and method described above is also particularly suited to identify any number of information blocks like data, textual elements or contextual links of the medicinal product information. The system and method are able to identify one individual information block of a selection of information blocks of the dismantled medicinal product information for a particular medicament and/or a selection of medicaments. This enables a health care professional or even the patient himself to more quickly identify the desired information within the entire set of information. This eliminates the need for reading through a large amount of textual information.

### DESCRIPTION OF THE DRAWINGS

An embodiment of the invention will now be described, by way of example only, with reference to the accompanying drawings, in which:

FIG. 1 shows an exemplary embodiment of a first part of the system according to the invention;

FIG. 2 shows an exemplary embodiment of a second part of the system according to the invention;

FIG. 3 shows a diagram of the principles of the information model used in the input module of the system; and

FIG. 4 shows a flowchart of the method according to the invention.

In the following text, the figures will be described one by one, and the different parts and positions seen in the figures will be numbered with the same numbers in the different figures. Not all parts and positions indicated in a specific figure will necessarily be discussed together with that figure.

Position number list

| | |
|---|---|
| 1 Servers | 8 Information model |
| 2 Cloud | 9 Data elements |
| 3 Standardisation module | 10 Groups |
| 4 Input module | 11 Sub-groups |
| 5Dismantled medicinal product information | 12 Users |
| 6 Sources | 13 Communication devices |
| 7 Entering data | 14 Communication module |
| 15 Links | 20 Internet |
| 16 Selected medicaments | 21 Retrieve data |
| 17 Selecting medicaments | 22 Merge data |
| 18 Selecting medicaments | 23 Return user interface |
| 19 Send request | |

### DETAILED DESCRIPTION OF THE INVENTION

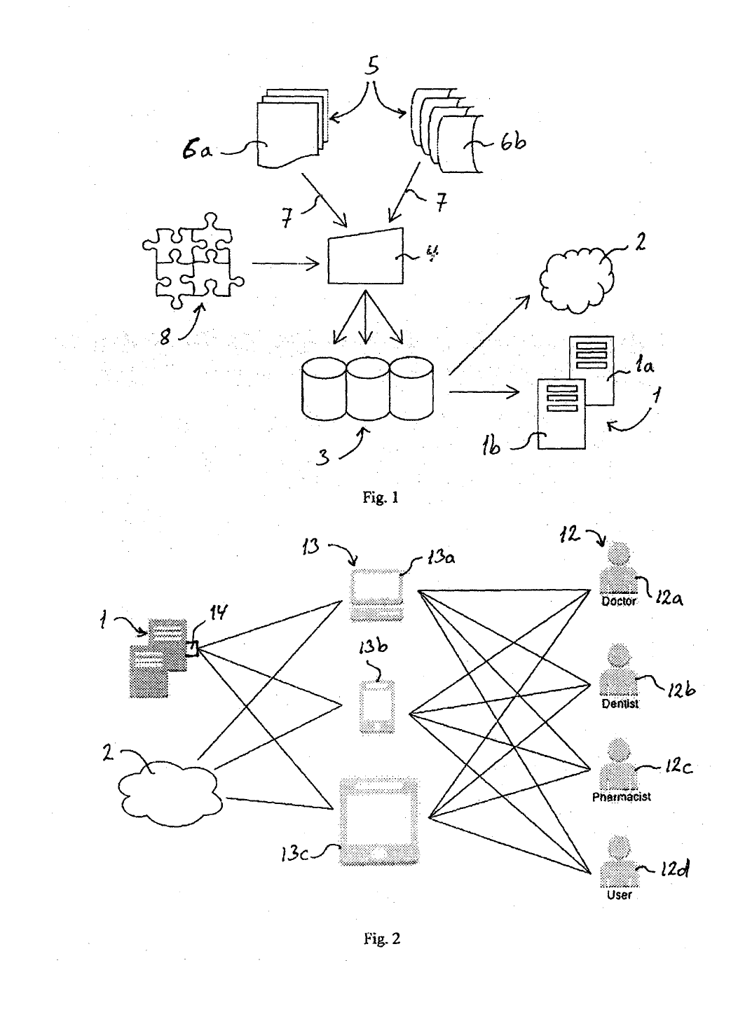

FIGS. 1 and 2 show an exemplary embodiment of the system according to the invention. FIG. 1 shows a first part of the system configured to input data into the system while FIG. 2 shows a second part of the system configured to extract data and present from the system.

The system comprises one or more computing devices in the form of central servers 1, e.g. database servers, or clouds 2, i.e. networks of computing devices like servers, configured to store dismantled medicinal product information of multiple medicaments (not shown). The dismantled medicinal product information is stored in a storage module (not shown) in the form of a database located in the server 1a or in a second server 1b dedicated to storing the dismantled medicinal product information. The server 1 or cloud 2 is loosely coupled to any number of standardisation modules 3 which in turn is coupled to any number of input modules 4.

The dismantled medicinal product information 5 relating to multiple medicaments is gathered from different sources 6, such as the official summary of product characteristics (also called SPC) 6a, the enclosed package leaflet (also called package insert), or information from public health authorities 6b. The dismantled medicinal product information 5 is also gathered from other public or private databases, organisational sources or other relevant sources. The collected dismantled medicinal product information 5 is usually stored in large textural documents and presented in different formats, either physically or electronic—but always as a whole, meaning that regardless of the information being stored in physical- or electronic documents, they are always presented as a large consistent textual representation. The dismantled medicinal product information 5 is entered 7 into the input module 4 either manually by an operator or automatically or a combination thereof.

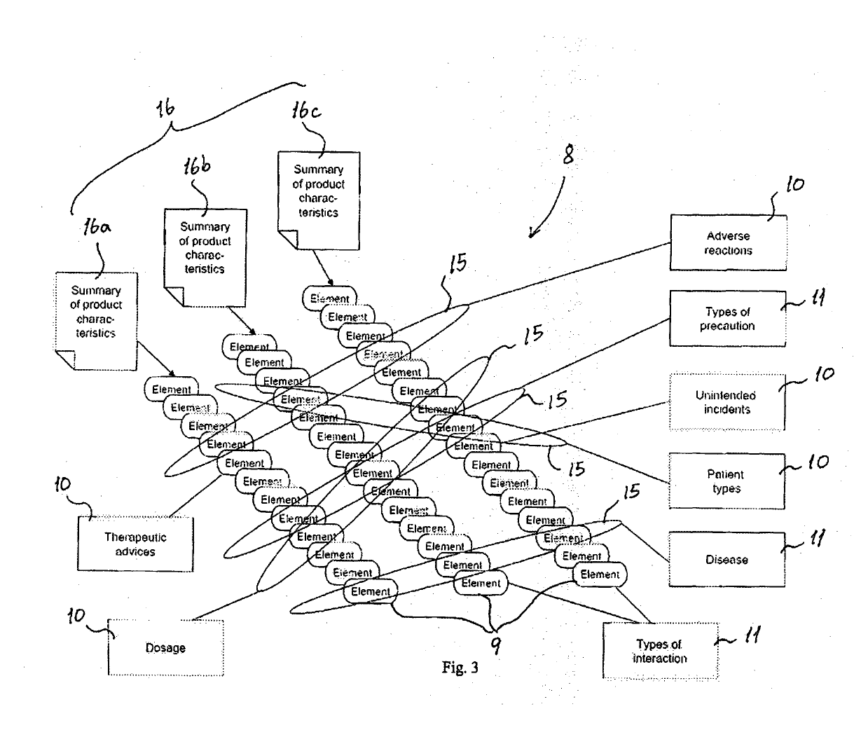

The input module 4 is configured to characterize, assign properties and relationships to the dismantled medicinal product information 5 gathered from the sources 6a, 6b according to a predetermined multi-dimensional information model 8, as shown in FIG. 3. The multi-dimensional information model 8 is defined by a predetermined set of elements 9 arranged in one or more groups 10. The elements 9 are further arranged in one or more sub-groups 11 of one or more of the groups 10. The groups 10, 11 and/or elements 9 may be linked according to the predetermined multi-dimensional information model 8. The information model 8 is stored in a database coupled to the input module 4.

The output of the input module 4 is then transferred to the standardisation module 3. The standardisation module 3 is configured to convert the phrased and terms used in the elements 9 into a standardised format. The conversion may be done manually by the operator or semi-automatic using a database comprising a plurality of well-defined and standardised terms and phrases. The standardised phrases and terms is defined according to internationally recognised phrases and terms defined by an international organisation and/or according to medical terminology used by professionals or the public health authority. If the phrases and/or terms already are in the predetermined format then no conversion is carried out. The output of the standardisation module 3 is then transferred to the server, e.g. a controller in the server, which stored the dismantled medicinal product information in the database.

One or more users 12 are able to communicate with the server 1 or cloud 2 using one or more communication devices 13. The communication devices 13 are configured to communicate with the server 1 or the cloud 2 via a communication module 14 coupled to the server 1 or cloud 2. The communication devices 13 are configured to communicate directly with the server 1/cloud 2 or via a network, e.g. a wired or wireless Internet network. The communication device 13 may be a stationary computer unit 13a, a mobile phone 13b in the form of a smart-phone, a tablet computer 13c, or another suitable communication device 13.

The communication device 13 is able to send a request to the server 1 or cloud 2 indicating the selected medicaments or the names of the medicaments. The request comprises a unique identifier, identifying the type of communication device 13a, 13b, 13c and/or the type of user 12a-d. The user 12 may be a doctor 12a, a dentist 12b, a pharmacist 12c or another user 12d, e.g. a patient or any other non-medical trained person. The server 1 or cloud 2 is configured to retrieve the dismantled medicinal product information for the selected medicaments from the database and combine the information into a dedicated package in the form of a dedicated user interface (not shown) for that user 12. The server 1 or cloud 2 is configured to store the dedicated packages in a storage module (not shown) in the form of a database coupled to the server 1/cloud 2 or generate it. A reply is then generated and transmitted back to the user 12 comprising a link to the dedicated user interface with dismantled medicinal product information, or adequate information to build a graphical user interface. The communication device 13 then presents the dedicated user interface to the user 12.

FIG. 3 shows a diagram illustrating some principles of the multi-dimensional information model 8 used in the input module 4 of the system. The elements 9 of the information module 8 define a predetermined set of data or textual elements that contains specific information relating to that particular medicament. The elements 9 are arranged in groups 10 which constitute a predetermined set of well-defined information blocks. The groups 10 or their sub-groups 11 are linked or related to other elements (marked with ellipses 15) to form the predetermined multi-dimensional information model 8 of medicinal product information. The link/relation 15 between groups 10, 11 or elements 9 may be fixed or contextual and may itself constitute an information block. The groups 10 may be properties like therapeutic indications, contraindications, unintended incidents, therapeutic advices, adverse reactions, packaging, administration methods, interactions, patient types, storage, or dosage. The subgroups 11 may be various diseases, different dosages, different methods of administration, different patient types, different types of precautions or interactions, or consequences of effects or adverse reactions. The groups 10, 11 may represent an international recognised classification system, e.g. the ICD-classification system, the ICPC-classification or the ATC-classification system.

The elements 9 of each medicament may be a standardised element used in several medicaments, as shown in FIG. 3. The standardised phrases and terms in the elements 9 enables the dismantled medicinal product information for the selected medicaments 16 to be displayed together in the dedicated user interface comprising an overview of the all the selected medicaments 16 as well as the information blocks of the individual medicaments.

The server 1 or cloud 2, e.g. the controller, may count the number of times that each of the 5 elements 9 is found in the selected medicaments 16, these elements 9 could be adverse reactions or any other group 10, 11 or terms of medicinal product information. Some of the elements 9 may only be in some of the selected medicaments 16, as shown in FIG. 3. The count is integrated into the dedicated user interface relative to the respective element 9. The count may be presented on the user interface using a number, a text and/or colour.

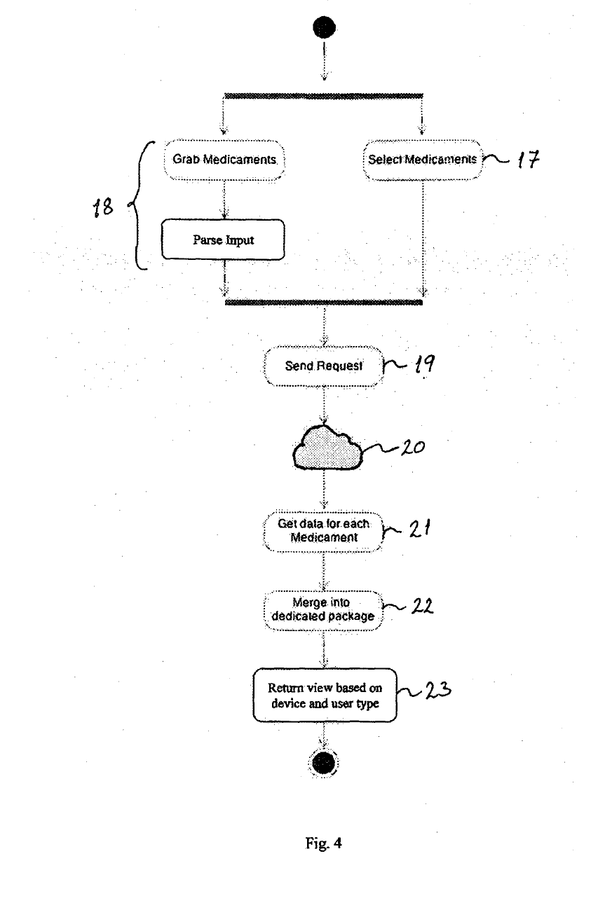

FIG. 4 shows a flowchart of the method according to the invention. The user 12 first selects 17 the desired medicaments via a list, e.g. located on a website of the server 1, the cloud 2 or on the communication device 13. The user 12 may also let the communication device 13 parse some input text, originating from a clinical system, a web browser or any other list to retrieve the medicaments 18. The user 12 and/or the communication device 13 then sends 19 the request, e.g. from the communication device 13 or the website, to the server 1 or cloud 2. This request may be send 19 over the Internet 20. The server 1 or cloud 2 receives the request via the communication module 14 and retrieves 21 the selected data, i.e. the medicinal product information, from the database. The server 1 or cloud 2 identifies the type of communication device 13ac and/or the user type 12a-d based on the request. The server 1 or cloud 13 then merges 22, i.e. combines, the retrieved data of those medicaments into a dedicated package, i.e. the dedicated user interface, optimised for that type of device 13 and/or the type of user 12. The server 1 or cloud 13 finally returns 23, i.e. transmits back a reply, a link indicating the location of the dedicated user interface, e.g. a dedicated webpage or adequate information for the communication device, to build the user interface. The communication device 13 then uses the link to access the dedicated user interface, or the information to build the user interface.

1. A system for managing dismantled medicinal product information of medicaments, such as identifying aggregate effects of the use of multiple medicaments or identifying at least one information block of dismantled medicinal product information of at least one medicament, where the system comprises
at least one computing device configured to store dismantled medicinal product information of a plurality of medicaments, wherein the dismantled medicinal product information at least comprises medicinal product characteristics of those medicaments;
at least one communication module coupled to the computing device and configured to communicate with at least one communication device;
where the communication device is further configured to send a request to the computing device and display the requested dismantled medicinal product information to a user of that communication device,
characterised by
the computing device is configured to combine the dismantled medicinal product information of a first medicament with the dismantled medicinal product information of at least a second medicament and generate a dedicated package, e.g. a user interface, for the combined dismantled medicinal product information, wherein the computing device is configured to send a reply back to the user via the communication module.

2. A system according to claim 1, characterised by the computing device comprises any number of input modules configured to process dismantled medicinal product information from one or more sources, wherein the input modules are configured to divide the medicinal product information into a set of elements and characterize, assign properties and relationships to them in accordance to a predetermined information model, e.g. a multi-dimensional information model.

3. A system according to claim 2, characterised by the input module being coupled to any number of standardisation modules configured to convert the information into a predetermined standardised format.

4. A system according to claim 1, characterised by the communication module being configured to determine the type of communication device and/or the type of user based on the received request.

5. A system according to claim 4, characterised by the computing device being configured to generate a dedicated user interface based on the type of communication device and/or the type of user, wherein the dedicated user interface is configured to display the dismantled medicinal product information of the selected medicaments.

6. A method of managing dismantled medicinal product information of medicaments, such as identifying aggregate effects of the use of multiple medicaments or identifying at least one information block of dismantled medicinal product information of at least one medicament, where the method comprises the steps of:
storing dismantled medicinal product information of a plurality of medicaments on at least one computing device, wherein the dismantled medicinal product information at least comprises medicinal product characteristics of those medicaments;
sending any number of requests from one or more users to the computing device using one or more communication devices, wherein the requests indicates one or more selected medicaments;
receiving a reply from the computing device and displaying the selected dismantled medicinal product information to the user on the communication device
characterised by
the computing device combines the dismantled medicinal product information of a first medicament with the dismantled medicinal product information of at least a second selected medicament and generates a dedicated package, e.g. a user interface, for the combined dismantled medicinal product information, where the computing device then sends a reply back to the user.

7. A method according to claim 6, characterised by the medicinal product information from one or more sources are processed in any number of input modules on the computing device, wherein the input modules divide the medicinal product information into a set of elements and characterize, assign properties and relationships to the elements according to a predetermined information model, e.g. a multi-dimensional information model.

8. A method according to claim 7, characterised by the output of the input modules is transferred to any number of standardisation modules, which convert the information into a predetermined standardised format.

9. A method according to claim 6, characterised by the type of communication device and/or the type of user is determined by the computing device based on the received request, and a dedicated user interface is generated by the computing device based on the type of communication device and/or the type of user.

10. Use of a system according to claim 1, a method of managing dismantled medicinal product information of medicaments, such as identifying aggregate effects of the use of multiple medicaments or identifying at least one information block of dismantled medicinal product information of at least one medicament, where the method comprises the steps of:
storing dismantled medicinal product information of a plurality of medicaments on at least one computing device, wherein the dismantled medicinal product information at least comprises medicinal product characteristics of those medicaments;
sending any number of request from one or more users to the computing device using one or more communication devices, wherein the requests indicates one or more selected medicaments;
receiving a reply from the computing device and displaying the selected dismantled medicinal product information to the user on the communication device
characterised by
the computing device combines the dismantled medicinal product information of a first medicament with the dismantled medicinal product information of at least a second selected medicament and generates a dedicated package, e.g. a user interface, for the combined dismantled medicinal product information, where the computing device then sends a reply back to the user, to identify aggregate effects, such as adverse reactions, resulting from the use of at least two medicaments.

11. Use of a system according to claim 1, a method of managing dismantled medicinal product information of medicaments, such as identifying aggregate effects of the use of multiple medicaments or identifying at least one information block of dismantled medicinal product information of at least one medicament, where the method comprises the steps of:
storing dismantled medicinal product information of a plurality of medicaments on at least one computing device, wherein the dismantled medicinal product information at least comprises medicinal product characteristics of those medicaments;
sending any number of requests from one or more users to the computing device using one or more communication devices, wherein the requests indicates one or more selected medicaments;
receiving a reply from the computing device and displaying the selected dismantled medicinal product information to the user on the communication device
characterised by
the computing device combines the dismantled medicinal product information of a first medicament with the dismantled medicinal product information of at least a second selected medicament and generates a dedicated package, e.g. a user interface, for the combined dismantled medicinal product information, where the computing
